(19) United States
(12) Patent Application Publication
(10) Pub. No.: US 2025/0390714 A1
(43) Pub. Date: Dec. 25, 2025

(54) QUESTION RECOMMENDATION APPARATUS, QUESTION RECOMMENDATION METHOD, AND PROGRAM

(71) Applicant: NIPPON TELEGRAPH AND TELEPHONE CORPORATION, Tokyo (JP)

(72) Inventors: Takashi HATTORI, Tokyo (JP); Hiroshi SAWADA, Tokyo (JP); Koji KAMEI, Tokyo (JP); Futoshi NAYA, Tokyo (JP)

(73) Assignee: NIPPON TELEGRAPH AND TELEPHONE CORPORATION, Tokyo (JP)

(21) Appl. No.: 18/877,429

(22) PCT Filed: Jun. 29, 2022
(86) PCT No.: PCT/JP2022/025898

§ 371 Date: Dec. 20, 2024

(51) Int. Cl. G06N 3/0455; G06N 3/047

(52) U.S. Cl. CPC G06N 3/0455; G06N 3/047

(57) ABSTRACT

Provided is a technique for recommending a question suitable for use in future study to a learner. Included are, setting a first latent variable vector as a latent variable vector obtained from an input vector obtained from test results of a learner of K questions using an encoder of a learned neural network, a first decoder unit that calculates a first predicted correct answer rate vector from the first latent variable vector using a decoder of the learned neural network, a latent variable vector generation unit that generates a second latent variable vector by a predetermined method from the first latent variable vector, a second decoder unit that calculates a second predicted correct answer rate vector from the second latent variable vector using the decoder of the learned neural network, and a question selection unit that preferentially selects an element having a larger value from elements of a vector obtained by subtracting the first predicted correct answer rate vector from the second predicted correct answer rate vector, and obtains a question corresponding to the index of the selected element as a question to be recommended to the learner.

### TECHNICAL FIELD

The present invention relates to a technique for recommending a learner a question suitable for use in future study.

### BACKGROUND ART

Various methods have been proposed as a method for analyzing a large amount of high-dimensional data. As one of such methods, there is a method using a variational autoencoder (VAE) described in Non Patent Literature 1. Here, the variational autoencoder is a neural network including an encoder and a decoder, the encoder is a neural network that converts an input vector into a latent variable vector, and the decoder is a neural network that converts the latent variable vector into an output vector. In addition, a latent variable vector is a vector having latent variables as its elements, and is a lower-dimensional vector than the input vector and the output vector. When an encoder of a variational autoencoder learned so that an input vector and an output vector are substantially the same is used, high-dimensional analysis target data can be converted and compressed into low-dimensional secondary data. Here, learning so as to be substantially the same is performed in a form of terminating processing assuming that the input vector and the output vector are the same when a predetermined condition is satisfied because in reality, learning has to be performed so as to be substantially the same due to a restriction of a learning time or the like although learning is preferably performed so as to be completely the same.

Non Patent Literature 1 discloses that when a variational autoencoder is learned to have monotonicity, a latent variable represents ability in a category such as “basic academic ability related to mathematics and Japanese”, “ability to manipulate words”, or “ability related to illustrations”, and a test result can be easily analyzed.

### CITATION LIST

### Non Patent Literature

Non Patent Literature 1: Takashi Hattori, Hiroshi Sawada, Takako Tonooka, Takeshi Sakata, Sanae Fujita, Tessei Kobayashi, Koji Kamei, Futoshi Naya, “Feature Extraction of Students and Problems via Exam Result Analysis using Variational Autoencoder”, The 34th Annual Conference of the Japanese Society for Artificial Intelligence, 3M1-GS-12-03, 2020.

### SUMMARY OF INVENTION

### Technical Problem

According to the method of Non Patent Literature 1, it is possible to obtain knowledge regarding the academic ability of a learner, such as having the “basic academic ability related to mathematics and Japanese” but being weak in the “ability to manipulate words”, for example. However, the method of Non Patent Literature 1 is for analyzing the test result, and does not suggest what kind of question the learner should use to advance his/her study in the future to improve his/her weak point. That is, the method of Non Patent Literature 1 cannot recommend a question suitable for use in future study to a learner.

Therefore, an object of the present invention is to provide a technique for recommending a question suitable for use in future study to a learner.

### Solution to Problem

One aspect of the present invention includes: setting input information as information indicating one of a positive state, a negative state, or an unknown state, setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state, setting p(x) as a probability that the input information x is information indicating the positive state, setting an output vector as a vector having probabilities p(x₁), . . . , p(x_{K}) for the K pieces of input information x₁, . . . , x_{K} as elements, a recording unit configured to record a parameter of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder so that the latent variable vector has monotonicity with respect to the input vector, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state; setting the K pieces of input information as test results of K questions, and setting the positive state, the negative state, and the unknown state as a correct answer, a wrong answer, and no answer, respectively, setting a first latent variable vector as a latent variable vector calculated from an input vector obtained from the test results of a learner of the K questions by using an encoder of the learned neural network or a latent variable vector corresponding to the input vector, a first decoder unit configured to calculate an output vector (hereinafter referred to as a first predicted correct answer rate vector) from the first latent variable vector using a decoder of the learned neural network; a latent variable vector generation unit configured to generate, as a second latent variable vector, a vector obtained by replacing at least one element of elements of the first latent variable vector with a value larger than a value of the element in a case where the monotonicity is monotonic increase, or a vector obtained by replacing at least one element of the elements of the first latent variable vector with a value smaller than the value of the element in a case where the monotonicity is monotonic decrease; a second decoder unit configured to calculate an output vector (hereinafter referred to as a second predicted correct answer rate vector) from the second latent variable vector using the decoder of the learned neural network; and a question selection unit configured to generate a vector obtained by subtracting the first predicted correct answer rate vector from the second predicted correct answer rate vector as a difference vector, preferentially select an element having a larger value from elements of the difference vector, and obtain a question corresponding to an index of the selected element as a question to be recommended to the learner.

### Advantageous Effects of Invention

According to the present invention, it is possible to recommend a question suitable for use in future study to a learner.

### BRIEF DESCRIPTION OF DRAWINGS

FIG. 1 is a diagram illustrating an example of an input vector representing a test result of a learner.

FIG. 2 is a block diagram illustrating a configuration of a neural network learning apparatus 100.

FIG. 3 is a flowchart illustrating an operation of the neural network learning apparatus 100.

FIG. 4 is a block diagram illustrating a configuration of a state estimation apparatus 200.

FIG. 5 is a flowchart illustrating an operation of the state estimation apparatus 200.

FIG. 6 is a block diagram illustrating a configuration of a question recommendation apparatus 300.

FIG. 7 is a flowchart illustrating an operation of the question recommendation apparatus 300.

FIG. 8 is a block diagram illustrating a configuration of a question recommendation apparatus 301.

FIG. 9 is a flowchart illustrating an operation of the question recommendation apparatus 301.

FIG. 10 is a diagram illustrating an example functional configuration of a computer that implements each device according to an embodiment of the present invention.

### DESCRIPTION OF EMBODIMENTS

Hereinafter, an embodiment of the present invention will be described in detail. Note that components having the same functions are denoted by the same reference numerals, and redundant description will be omitted.

Prior to description of embodiments, a notation method in the present specification will be described.

\hat{ }(caret) represents a superscript. For example, x^{y\hat{ }z} represents that y^{z} is a superscript for x, and x_{y\hat{ }z} represents that y^{z} is a subscript for x. Furthermore, _ (underscore) represents a subscript. For example, x^{y_z} represents that y_{z} is a superscript for x, and x_{y_z} represents that y_{z} is a subscript for x.

Further, a superscript “\hat{ }” or “˜” as in \hat{ }x or ˜x for a certain character x would normally be written directly above the “x”, but is written herein as \hat{ }x or ˜x due to restrictions of notation in the description.

### TECHNICAL BACKGROUND

Here, a method of learning a neural network used in the embodiments of the present invention will be described. A neural network used in the embodiments of the present invention is a neural network including an encoder that calculates a latent variable vector from an input vector and a decoder that calculates an output vector from the latent variable vector.

Hereinafter, the input vector, the encoder, the output vector, a loss function, and monotonicity of the neural network according to the embodiments of the present invention will be described.

### (1: Input Vector)

In the embodiments of the present invention, the input vector is a vector representing a plurality of pieces of input information. Here, the input information is information indicating any of a positive state, a negative state, or an unknown state. Hereinafter, examples of the input vector and the input information will be described. In the above example of analysis of test results, there may be generally three types of test results of each question of a learner: correct answer, wrong answer, and no answer. Here, the “no answer” is a case where an answer to a question does not exist because the learner has not taken an examination such as a case where the learner has taken tests of Japanese and mathematics but has not taken tests of science and social studies. Therefore, in the example of analysis of test results, it is possible to express the test results of the plurality of questions of the learner as the input vector by expressing the test results of the respective questions of the learner as the input information where the correct answer, the wrong answer, and the no answer respectively correspond to a positive state, a negative state, and an unknown state. Further, another example includes analysis of information acquired by a plurality of sensors. When a sensor that detects the presence or absence of a predetermined situation is used, two types of information can be acquired: information indicating that the situation has been detected (that is, detection); and information indicating that the situation has not been detected (that is, non-detection). However, in a case where information acquired by a plurality of sensors is collected and analyzed via a communication network, information indicating that a predetermined situation has been detected or information indicating that no predetermined situation has been detected for any of the sensors may not be obtained due to loss of a communication packet or the like, and any information may not be obtained (that is, unknown situation). Therefore, in this example, it is possible to express detection results of the plurality of sensors as the input vector by expressing the detection results as the input information of the respective sensors where the detection, non-detection, and situation unknown respectively correspond to the positive state, the negative state, and the unknown state.

Then, the input vector has features as follows.

[Feature 1] The input vector is a vector including a positive information bit group and a negative information bit group.

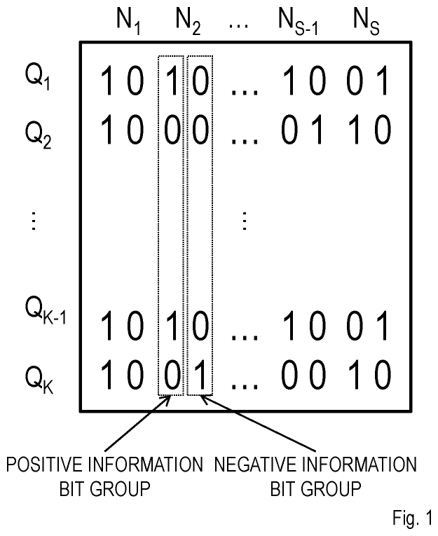

Hereinafter, description will be given using the example of analysis of test results. It is assumed that the test result of the learner is represented by using two bits of a positive information bit in which the correct answer is 1 and the no answer or the wrong answer is 0 and a negative information bit in which the wrong answer is 1 and the no answer or the correct answer is 0. In this way, x⁽¹⁾ₛₖ and x⁽⁰⁾ₛₖ are set as the positive information bit and the negative information bit for the test result of a k-th question of an s-th learner, respectively, and the input vector representing the test results of K questions of the s-th learner is a vector including the positive information bit group {x⁽¹⁾ₛ₁, x⁽¹⁾ₛ₂, . . . , x⁽¹⁾_{sK}} and the negative information bit group {x⁽⁰⁾ₛ₁, x⁽⁰⁾ₛ₂, . . . , x⁽⁰⁾_{sK}}. FIG. 1 illustrates an example of the input vector representing the test result of the learner. Here, Q₁, . . . , and Q_{K} in FIG. 1 represent the first question, . . . , and the K-th question, N₁, . . . , and N_{S} represent the first learner, . . . , and the S-th learner, a row represent a list of pairs of the positive information bit and the negative information bit of all the learners for each question, and a column represent a list of the positive information bit groups and the negative information bit groups for all the questions of each learner. For example, the input vector of the second learner is a vector including the positive information bit group {1, 0, . . . , 1, 0} and the negative information bit group {0, 0, . . . , 0, 1}. Further, the test result of the second question of the second learner is no answer since both the positive information bit and the negative information bit are 0.

### (2: Encoder)

The encoder in the embodiments of the present invention has the following feature.

[Feature 2]A first layer (that is, a layer to which the input vector is input) of the encoder is assumed to be a layer in which intermediate information is obtained from the positive information bit group and the negative information bit group included in the input vector, the intermediate information preventing an element of the input vector corresponding to the input information indicating the unknown state from affecting the output of the encoder.

Hereinafter, description will be given using the example of analysis of test results. {qₛ₁, qₛ₂, . . . , q_{sH}} is set as an intermediate information group of the s-th learner, which is the output of the first layer of the encoder, and intermediate information qₛₕ is obtained by the following equation.

$$[ Math . 1 ]$$

$${q}_{sh} = {\sum }_{k = 1}^{K} {w}_{hk}^{( 1 )} {x}_{sk}^{( 1 )} + {\sum }_{k = 1}^{K} {w}_{hk}^{( 0 )} {x}_{sk}^{( 0 )} + {b}_{h} \qquad ( 1 )$$

Note that w⁽¹⁾ₕₖ and w⁽⁰⁾ₕₖ are a weight parameter for the h-th intermediate information with respect to the positive information bit x⁽¹⁾ₛₖ and a weight parameter for the h-th intermediate information with respect to the negative information bit x⁽⁰⁾ₛₖ, respectively, and bₕ is a bias parameter for the h-th intermediate information.

In a case where the test result of the k-th question of the s-th learner is the correct answer, x⁽¹⁾ₛₖ=1 and x⁽⁰⁾ₛₖ=0 are obtained. Therefore, only w⁽¹⁾ₕₖ out of the two weight parameters w⁽¹⁾ₕₖ and w⁽⁰⁾ₕₖ reacts, and w⁽⁰⁾ₕₖ does not react. Furthermore, in a case where the test result of the k-th question of the s-th learner is the wrong answer, x⁽¹⁾ₛₖ=0 and x⁽⁰⁾ₛₖ=1 are obtained. Therefore, only w⁽⁰⁾ₕₖ out of the two weight parameters w⁽¹⁾ₕₖ and w⁽⁰⁾ₕₖ reacts, and w⁽¹⁾ₕₖ does not react. Moreover, in a case where the test result of the k-th question of the s-th learner is the no answer, x⁽¹⁾ₛₖ=0 and x⁽⁰⁾ₛₖ=0 are obtained. Therefore, both the two weight parameters w⁽¹⁾ₕₖ and w⁽⁰⁾ₕₖ do not react. Note that reacting means that the weight parameter is updated at the time of learning and the weight parameter affects at the time of using the learned encoder, and non-reacting means that the weight parameter is not updated at the time of learning and the weight parameter does not affect at the time of using the learned encoder. Therefore, by using the equation (1), it is possible to obtain the intermediate information that affects the output of the encoder in the case where the input information is either information indicating the correct answer or information indicating the wrong answer, but does not affect the output of the encoder in the case where the input information is information indicating the no answer. Note that the neural network in or after a second layer of the encoder may be any neural network as long as a latent variable vector Zₛ is calculated from the intermediate information group {qₛ₁, qₛ₂, . . . , q_{sH}}.

### (3: Output Vector)

The output vector in the embodiments of the present invention has the following feature.

[Feature 3] When p(x) is a probability that the input information x is information indicating the positive state, the output vector is a vector having probabilities p(x₁), . . . , p(x_{K}) for K pieces of input information x₁, . . . , x_{K} as elements.

Therefore, by using the example of analysis of test results, the decoder uses the latent variable vector Zₛ as an input, and obtains, as the output vector, a probability vector Pₛ=(pₛ₁, pₛ₂, . . . , p_{sK}) having the probability pₛₖ that the s-th learner will correctly answer the k-th question as an element.

### (4: Loss Function)

The loss function in the embodiments of the present invention has the following feature.

[Feature 4] The loss function includes a loss term that does not allow the input information to be a loss, the input information being information indicating the no answer.

Hereinafter, description will be given using the example of analysis of test results. The loss function is set to a loss function including a term L_{RC} regarding a reconstruction error calculated by the following equation representing a sum of losses Lₛₖ for all the questions of all the learners, where the loss Lₛₖ regarding the k-th question of the s-th learner is set as −log(p_{sK}) in the case of x⁽¹⁾ₛₖ=1 (that is, in the case where the test result is the correct answer), set as −log (1−pₛₖ) in the case of x⁽⁰⁾ₛₖ=1 (that is, in the case where the test result is the wrong answer), and set as 0 in the case of x⁽¹⁾ₛₖ=0 and x⁽⁰⁾ₛₖ=0 (that is, the test result is the no answer).

$$[ Math . 2 ]$$

$${L}_{RC} = {\sum }_{s = 1}^{S} {\sum }_{k = 1}^{K} {L}_{sk} \qquad ( 2 )$$

−log(p_{sK}) has a larger value as the probability p_{sK} that the s-th learner will correctly answer the k-th question is smaller (that is, as the probability is further away from 1) even though the s-th learner has actually given the correct answer to the k-th question. Further, −log(1−pₛₖ) has a larger value as the probability pₛₖ that the s-th learner will correctly answer the k-th question is larger (that is, as the probability is further away from 0) even though the s-th learner has actually given the wrong answer to the k-th question.

### (5: Monotonicity of Neural Network)

The neural network in the embodiment of the present invention has monotonicity. Here, the monotonicity of the neural network and learning the neural network having the monotonicity will be described.

In the embodiments of the present invention, the neural network is learned such that the latent variable vector has the following feature (hereinafter referred to as feature 5-1) in order to make a certain latent variable included in the latent variable vector larger or a certain latent variable included in the latent variable vector smaller as magnitude of a certain property included in the input vector is larger.

[Feature 5-1] Learning is performed such that a latent variable vector has monotonicity with respect to an input vector. Here, the latent variable vector having the monotonicity with respect to the input vector means having a relationship of either a monotonic increase in which the latent variable vector increases as the input vector increases, or a monotonic decrease in which the latent variable vector decreases as the input vector increases. Note that the magnitude of the input vector and the latent variable vector is based on an order relationship regarding the vectors (that is, a relationship defined using an order relationship regarding each element of the vectors), and for example, the following order relationship can be used.

Holding of v≤v′ for the vectors v=(v₁, . . . , vₙ) and v′=(v′₁, . . . , v′ₙ) means that holding of vᵢ≤v′ᵢ for all the elements of the vectors v and v′, that is, for the i-th element vᵢ of the vector v and the i-th element v′ᵢ of the vector v′ (where i=1, . . . , n).

Learning the neural network so that the latent variable vector has the monotonicity with respect to the input vector specifically means learning the neural network so that the latent variable vector has one of the following first and second relationships with the input vector.

The first relationship is a relationship in which, when two input vectors are a first input vector and a second input vector, and in a case where for at least one element of the input vectors, a value of the one element of the first input vector is greater than a value of the one element of the second input vector, and for all the remaining elements of the input vectors, values of the remaining elements of the first input vector are greater than or equal to values of the remaining elements of the second input vector, when a latent variable vector obtained by converting the first input vector is a first latent variable vector and a latent variable vector obtained by converting the second input vector is a second latent variable vector, for at least one element of the latent variable vectors, a value of the one element of the first latent variable vector is greater than a value of the one element of the second latent variable vector, and for all the remaining elements of the latent variable vectors, values of the remaining elements of the first latent variable vector are greater than or equal to values of the remaining elements of the second latent variable vector.

The second relationship is a relationship in which, when two input vectors are the first input vector and the second input vector, and in the case where for at least one element of the input vectors, the value of the one element of the first input vector is greater than the value of the one element of the second input vector, and for all the remaining elements of the input vectors, the values of the remaining elements of the first input vector are greater than or equal to the values of the remaining elements of the second input vector, when a latent variable vector obtained by converting the first input vector is the first latent variable vector and a latent variable vector obtained by converting the second input vector is the second latent variable vector, for at least one element of the latent variable vectors, the value of the one element of the first latent variable vector is less than the value of the one element of the second latent variable vector, and for all the remaining elements of the latent variable vectors, the values of the remaining elements of the first latent variable vector are less than or equal to the values of the remaining elements of the second latent variable vector.

Then, it is said that, when the latent variable vector is in the first relationship with the input vector, the latent variable vector monotonically increases with respect to the input vector, or the neural network monotonically increases. And it is said that, when the latent variable vector is in the second relationship with the input vector, the latent variable vector monotonically decreases with respect to the input vector, or the neural network monotonically decreases. In addition, it is said that, when the neural network monotonically increases or monotonically decreases, the neural network has the monotonicity.

By performing learning such that the latent variable vector has the above feature 5-1, a certain latent variable that satisfies the condition that the certain latent variable included in the latent variable vector is larger or the certain latent variable included in the latent variable vector is smaller as the magnitude of a certain property included in the input vector is larger is provided.

In addition, in the embodiments of the present invention, there is a case where the neural network is learned on the assumption that the latent variable also has the following feature (hereinafter referred to as feature 5-2).

[Feature 5-2] Learning is performed such that an available value for the latent variable becomes a value falling in a predetermined range.

Note that the predetermined range is referred to as a latent variable value range.

For example, a sigmoid function or a function s(x) of the following equation may be used as an activation function of an output layer of the encoder so that the available value for the latent variable becomes the value falling in the predetermined range.

$$[ Math . 3 ]$$

$$s ( x ) = m + \frac{M - m}{1 + {e}^{- x}} \qquad ( 3 )$$

(Here, m<M)

By using the sigmoid function as the activation function, the value of the element of the latent variable vector that is the output of the encoder (that is, each latent variable) becomes 0 or more and 1 or less, and an available value range for the latent variable can be set to [0, 1]. In addition, by using the function s(x) of the equation (3) as the activation function, the available value range for the latent variable can be set to [m, M].

Hereinafter, restrictions for learning the neural network including the encoder that outputs the latent variable vector having the feature of the above feature 5-1 will be described. Specifically, the following two restrictions will be described.

[Restriction 1] Learning is performed so as to minimize the loss function including the loss term for monotonicity violation.

[Restriction 2] Learning is performed by restricting all the weight parameters of the decoder to be non-negative values or restricting all the weight parameters of the decoder to be non-positive values.

First, the loss function including the loss term of the restriction 1 will be described. A loss function L is defined as a function including a term Lₘₒₙₒ for causing the latent variable vector to have the monotonicity with respect to the input vector. For example, the loss function L can be a function defined by the following equations. Note that the term Lₘₒₙₒ in the following equations is an equation including a term regarding the feature 5-1 in addition to a term regarding the feature 5-2.

$$[ Math . 4 ]$$

$$L = {L}_{RC} + {L}_{mono} \qquad ( 4 )$$

$${L}_{mono} = {L}_{real} + {\sum }_{p = 1}^{2} {L}_{syn - encoder}^{( p )} + {\sum }_{p = 1}^{2} {L}_{syn - decoder}^{( p )} \qquad ( 5 )$$

The term L_{RC} is a term regarding the reconstruction error of the equation (2). Further, the term Lₘₒₙₒ is a sum of three kinds of terms Lᵣₑₐₗ, L_{syn-encoder}^{(p)}, and L_{syn-decoder}^{(p)} The term Lᵣₑₐₗ is a term for establishing the monotonicity, that is, a term regarding the feature 5-1. Meanwhile, the term L_{syn-encoder}^{(p)} and the term L_{syn-decoder}^{(p)} are terms regarding the feature 5-2.

Hereinafter, an example of the term Lᵣₑₐₗ for establishing the relationship of the monotonic increase will be described together with a learning method. First, the input vector is input to the encoder, and the latent variable vector (hereinafter referred to as the original latent variable vector) is obtained as an output. Next, a vector in which the value of at least one element of the original latent variable vector is replaced with a value smaller than the value of the element is obtained. Hereinafter, the vector obtained here is referred to as an artificial latent variable vector. Note that the artificial latent variable vector may be obtained as a vector in which the value of at least one element of the original latent variable vector is replaced with a value that is equal to or larger than a lower limit of an available range for the value of the element and is smaller than the value of the element. In the present specification, words with “artificial” such as the “artificial latent variable vector” are used, but the words are for describing that the artificial latent variable vector is not the original latent variable, and are not intended to be obtained by manual work.

Here, an example of processing of obtaining the artificial latent variable vector will be described. For example, the artificial latent variable vector is generated by decreasing the value of one element of the original latent variable vector within the available range for the value of the element. In the artificial latent variable vector thus obtained, the value of any one element is smaller than that of the original latent variable vector, and the values of the other elements are the same. Note that a plurality of the artificial latent variable vectors may be generated by decreasing the values of different elements of the latent variable vector within available ranges for the values of the elements. Further, the artificial latent variable vector may be generated by decreasing the values of a plurality of elements of the latent variable vector within available ranges for the values of the elements. That is, the artificial latent variable vector in which the values of a plurality of elements are smaller than those of the original latent variable vector and the values of the remaining elements are the same may be generated. Furthermore, a plurality of the artificial latent variable vectors may be generated by decreasing, for a plurality of sets of a plurality of elements of the latent variable vector, the value of each element included in each set within the available range for the value of the each element.

As a method of obtaining the value of the element of the artificial latent variable vector from the value of the element of the original latent variable vector, the value of the artificial latent variable vector being smaller than that of the original latent variable vector, in a case where the lower limit of the available range for the value of the element is 0, for example, a method of multiplying the value of the element of the original latent variable vector by a random number in a section (0, 1) to reduce the value to obtain the value of the element of the artificial latent variable vector, or a method of multiplying the value of the element of the original latent variable vector by ½ to halve the value to obtain the value of the element of the artificial latent variable vector may be used.

In a case of using the artificial latent variable vector in which the value of the element of the original latent variable vector is replaced with a value smaller than the value of the element, the value of each element of the output vector when the original latent variable vector is input is desirably larger than the value of the corresponding element of the output vector when the artificial latent variable vector is input. Therefore, the term Lᵣₑₐₗ is only required to be set to a term having a larger value in a case where, for example, the value of the corresponding element of the output vector when the original latent variable vector is input is smaller than the value of each element of the output vector when the artificial latent variable vector is input. Note that, in a case where the element of the input vector is the information indicating the unknown state, it is desirable not to calculate the loss for the element. Therefore, the term Lᵣₑₐₗ is preferably a term in which the loss is not calculated for the element indicating the unknown state (that is, the loss is set to 0), and the term with the loss of a value of 0 or more and having a larger value in the case where the value of the corresponding element of the output vector when the original latent variable vector is input is smaller than the value of each element of the output vector when the artificial latent variable vector is input, for the other elements (that is, elements indicating the positive state or the negative state). Therefore, in the example of analysis of test results, the term Lᵣₑₐₗ can be defined by the following equation using a margin ranking error.

$$[ Math . 6 ]$$

$${L}_{real} = {\sum }_{s = 1}^{S} {\sum }_{k = 1}^{K} {L}_{sk}^{′} \qquad ( 6 )$$

$$[ Math . 7 ]$$

$${L}_{sk}^{′} = \{ \begin{matrix}0 & ( {x}_{sk}^{( 1 )} = {x}_{sk}^{( 0 )} = 0 ) \\ max \{ 0 , {p}_{sk}^{′} - {p}_{sk} \} & ( otherwise )\end{matrix} \qquad ( 7 )$$

Here, P′ₛ=(p′ₛ₁, p′ₛ₂, . . . , p′_{sK}) is a probability vector having, as an element, a probability p′ₛₖ that the s-th learner will correctly answer the k-th question when the artificial latent variable vector is input.

Learning is performed using the artificial latent variable vector generated as described above and the term Lᵣₑₐₗ.

Note that, instead of using the vector in which the value of at least one element of the original latent variable vector is replaced with a value smaller than the value of the one element as the artificial latent variable vector, a vector in which the value of at least one element of the original latent variable vector is replaced with a value larger than the value of the one element may be used as the artificial latent variable vector. In this case, the value of each element of the output vector when the original latent variable is input is desirably smaller than the value of the corresponding element of the output vector when the artificial latent variable is input. Therefore, the term Lᵣₑₐₗ is only required to be set to a term having a larger value in a case where the value of each element of the output vector when the original latent variable vector is input is larger than the value of the corresponding element of the output vector when the artificial latent variable vector is input. Note that, in a case where the element of the input vector is the information indicating the unknown state, it is desirable not to calculate the loss for the element. Therefore, the term Lᵣₑₐₗ is preferably a term in which the loss is set to 0 for the element indicating the unknown state, and the term with the loss of a value of 0 or more and having a larger value in the case where the value of the corresponding element of the output vector when the original latent variable vector is input is larger than the value of each element of the output vector when the artificial latent variable vector is input, for the other elements (that is, elements indicating the positive state or the negative state).

As a method of obtaining the value of the element of the artificial latent variable vector from the value of the element of the original latent variable vector, the value of the artificial latent variable vector being larger than that of the original latent variable vector, in a case of obtaining, from the value of the element of the original latent variable vector, the value of the element of the artificial latent variable vector, the value being equal to or less than the upper limit of the available range for the value of the original latent variable vector, and being larger than the value of the original latent variable vector, a method of obtaining a value randomly selected from between the value of the element of the original latent variable vector and the upper limit of the available range for the value of the element, as the value of the element of the artificial latent variable vector, or a method of obtaining an average value of the value of the element of the original latent variable vector and the upper limit of the available range for the value of the element, as the value of the element of the artificial latent variable vector, may be used.

The term L_{syn-encoder}^{(p)} is a term regarding artificial data in which the values of all the elements of the positive information bit group of the input vector are an upper limit of 1 of the available value range and the values of all the elements of the negative information bit group of the input vector are a lower limit of 0 of the available value range, or artificial data in which the values of all the elements of the positive information bit group of the input vector are the lower limit of 0 of the available value range and the values of all the elements of the negative information bit group of the input vector are the upper limit of 1 of the available value range. For example, the term L_{syn-encoder}^{(p)} is a term regarding artificial data in which the input vector is a vector (1, 0, . . . , 1, 0) corresponding to the correct answers given to all the questions, or artificial data in which the input vector is a vector (0, 1, . . . , 0, 1) corresponding to the wrong answers being given to all the questions.

Specifically, the term L_{syn-encoder}⁽¹⁾ is a binary cross entropy of the latent variable vector that is the output of the encoder in the case where the input vector is the vector (1, 0, . . . , 1, 0) corresponding to the correct answers given to all the questions and a vector in which all the elements are the upper limit of the available value range (for example, the vector (1, . . . , 1 in the case where the upper limit of the available value range for all the elements of the latent variable vector is 1), the vector being an ideal latent variable vector in the case where the input vector is the vector (1, 0, . . . , 1, 0) corresponding to the correct answers given to all the questions. Further, the term L_{syn-encoder}⁽²⁾ is a binary cross entropy of the latent variable vector that is the output of the encoder in the case where the input vector is the vector (0, 1, . . . , 0, 1) corresponding to the wrong answers given to all the questions and a vector in which all the elements are the lower limit of the available value range (for example, the vector (0, . . . , 0 in the case where the lower limit of the available value range for all the elements of the latent variable vector is 0), the vector being an ideal latent variable vector in the case where the input vector is the vector (0, 1, . . . , 0, 1) corresponding to the wrong answers given to all the questions. The term L_{syn-encoder}⁽¹⁾ is based on the requirement that it is desirable that all the elements of the latent variable vector are the upper limit of the available value range when the values of all the elements of the positive information bit group of the input vector are the upper limit of 1 of the available value range, and the values of all the elements of the negative information bit group of the input vector are the lower limit of 0 of the available value range, and the term L_{syn-encoder}⁽²⁾ is based on the requirement that it is desirable that all the elements of the latent variable vector are the lower limit of the available value range when the values of all the elements of the positive information bit group of the input vector are the lower limit of 0 of the available value range, and the values of all the elements of the negative information bit group of the input vector are the upper limit of 1 of the available value range.

Meanwhile, the term L_{syn-decoder}^{(p)} is a term regarding artificial data in which the values of all the elements of the out vector are the upper limit of 1 of the available value range, or artificial data in which the values of all the elements of the output vector are the lower limit of 0 of the available value range. For example, the term L_{syn-decoder}^{(p)} is a term regarding artificial data that is the vector (1, . . . , 1 corresponding to the probability that is an element of the output vector being 1, or artificial data that is the vector (0, . . . , 0 corresponding to the probability that is an element of the output vector being 0. Specifically, the term L_{syn-decoder}⁽¹⁾ is a binary cross-entropy of the output vector that is the output of the decoder in the case where the latent variable vector is the vector in which the values of all the elements are the upper limit of the available value range (for example, the vector (1, . . . , 1 in the case where the upper limit of the available value range for all the elements of the latent variable vector is 1) and the vector (1, . . . , 1 in which all the elements are 1 (that is, corresponding to all the probabilities being 1), the vector being an ideal output vector in the case where the values of all the elements of the latent variable vector are the upper limit of the available value range. Further, the term L_{syn-decoder}⁽²⁾ is a binary cross-entropy of the output vector that is the output of the decoder in the case where the latent variable vector is the vector in which the values of all the elements are the lower limit of the available value range (for example, the vector (0, . . . , 0 in the case where the lower limit of the available value range for all the elements of the latent variable vector is 0) and the vector (0, . . . , 0 in which all the elements are 0 (that is, corresponding to all the probabilities being 0), the vector being an ideal output vector in the case where the values of all the elements of the latent variable vector are the lower limit of the available value range. The term L_{syn-decoder}⁽¹⁾ is based on the requirement that it is desirable that all the elements of the output vector is 1 (that is, the upper limit of the available value range) when all the elements of the latent variable vector are the upper limit of the available value range, and the term L_{syn-decoder}⁽²⁾ is based on the requirement that it is desirable that all the elements of the output vector are 0 (that is, the lower limit of the available value range) when all the elements of the latent variable vector is the lower limit of the available value range.

Since the loss function includes the term Lᵣₑₐₗ defined as described above, the neural network is learned to have the features that, when two input vectors are the first input vector and the second input vector, and in the case where, for at least one element of the input vectors, the value of the one element of the first input vector is greater than the value of the one element of the second input vector, and for all the remaining elements of the input vectors, the values of the remaining elements of the first input vector are greater than or equal to the values of the remaining elements of the second input vector, when the latent variable vector obtained by converting the first input vector is the first latent variable vector and the latent variable vector obtained by converting the second input vector is the second latent variable vector, for at least one element of the latent variable vectors, the value of the one element of the first latent variable vector is greater than the value of the one element of the second latent variable vector, and for all the remaining elements of the latent variable vectors, the values of the remaining elements of the first latent variable vector are greater than or equal to the values of the remaining elements of the second latent variable vector. Furthermore, since the loss function L further includes the terms L_{syn-encoder}^{(p)} and L_{syn-decoder}^{(p)} in addition to the term Lᵣₑₐₗ, the neural network is learned so that the values of all the elements of the latent variable vector are included in the available value range.

Next, a learning method of the restriction 2 will be described. In the description of the learning method of the restriction 2, a number of the input vector used for learning is s (s is an integer of 1 or more and S or less, and S is the number of pieces of learning data), a number of the element of the latent variable vector is j (j is an integer of 1 or more and J or less), numbers of the elements of the input vector and the output vector are k (k is an integer of 1 or more and K or less, and K is an integer greater than J), the input vector is Xₛ, the latent variable vector obtained by converting the input vector Xₛ is Zₛ, the output vector obtained by converting the latent variable vector Zₛ is Pₛ, the k-th element of the input vector xₛ is xₛₖ, the j-th element of the latent variable vector Zₛ is zₛⱼ, and the k-th element of the output vector Pₛ is pₛₖ.

The encoder may be any encoder as long as that converts the input vector xₛ into the latent variable vector Zₛ. Further, the loss function used for learning may be a loss function including the reconstruction error term L_{RC} of the equation (2).

The decoder converts the latent variable vector Zₛ into the output vector Pₛ, and is learned by restricting all the weight parameters of the decoder to be non-negative values or restricting all the weight parameters of the decoder to be non-positive values.

The restriction of the decoder will be described using an example of restricting all the weight parameters of the decoder configured with one layer to be non-negative values. The input vector of the s-th learner is Xₛ=(xₛ₁, xₛ₂, . . . , x_{sK}), the latent variable vector obtained by converting the input vector xₛ by the encoder is Zₛ=(zₛ₁, zₛ₂, . . . , z_{sJ}), and the output vector obtained by converting the latent variable vector Zₛ by the decoder is Pₛ=(pₛ₁, pₛ₂, . . . , p_{sK}). In order for the learner to give the correct answer to each question, for example, it is considered that abilities in various categories such as writing ability and illustration ability are required with weights. To cause each element of the latent variable vector to correspond to each category of the ability and to cause the value of the latent variable corresponding to each category that the learner has to be larger as the magnitude of the ability of the category that the learner has is larger, the probability p_{sK} at which the s-th learner correctly answers the k-th question is calculated by the following equation using a weight parameter wⱼₖ for the k-th question given to the j-th latent variable zₛⱼ as a non-negative value.

$$[ Math . 8 ]$$

$${p}_{sk} = σ ( {z}_{s 1} {w}_{1 k} + {z}_{s 2} {w}_{2 k} + ⋯ + {z}_{sJ} {w}_{Jk} + {b}_{k} ) \qquad ( 8 )$$

Here, σ is the sigmoid function, and bₖ is the bias parameter for the k-th question. The bias parameter bₖ is a parameter corresponding to a difficulty level that does not depend on the ability of the above-described each category for the k-th question. That is, in the case of the decoder configured with one layer, by learning the neural network by restricting all the weight parameters wⱼₖ (j=1, . . . , J and k=1, . . . , K) to be non-negative values for all the questions and all the latent variables, it is possible to obtain the encoder that obtains the latent variable vector in which a certain latent variable becomes larger as the magnitude of the ability of a certain category is larger for the ability of each category from the input vector for each learner.

From the above, in order to make a certain latent variable included in the latent variable vector larger as the magnitude of a certain property included in the input vector is larger, learning is performed while restricting all the weight parameters of the decoder to be non-negative values. Furthermore, as can be seen from the above description, in the case of making a certain latent variable included in the latent variable vector smaller as the magnitude of a certain property included in the input vector is larger, it is preferable to perform learning while restricting all the weight parameters of the decoder to be non-positive values.

### First Embodiment

A neural network learning apparatus 100 learns parameters of a neural network to be learned using learning data. Here, the neural network to be learned includes an encoder that calculates a latent variable vector from an input vector and a decoder that calculates an output vector from the latent variable vector. Furthermore, the parameters of the neural network include a weight parameter and a bias parameter of the encoder, and a weight parameter and a bias parameter of the decoder.

The input information is information indicating one of a positive state, a negative state, or an unknown state, and the input vector is a vector obtained from K pieces (K is an integer of 2 or more) of input information x₁, . . . , and x_{K} by expressing the input information by using two bits of a positive information bit set to 1 when the input information is information indicating the positive state, or set to 0 when the input information is information indicating the unknown state or information indicating the negative state, and a negative information bit set to 1 when the input information is information indicating the negative state, or set to 0 when the input information is information indicating the unknown state or information indicating the positive state. Therefore, the input vector is a vector with an element of 0 or 1. Further, p(x) is a probability that input information x is information indicating the positive state, and the output vector is a vector having probabilities p(x₁), . . . , p(x_{K}) for the K pieces of input information x₁, . . . , x_{K} as elements. The latent variable vector is a vector having the latent variable as an element.

Note that, as described in <Technical Background>, a first layer of the encoder obtains a vector having H pieces of intermediate information qₛ₁, . . . , q_{sH} as elements from the input vector, setting x⁽¹⁾ₛₖ and x⁽⁰⁾ₛₖ as the positive information bit and the negative information bit with respect to the input information xₖ of s-th learning data, respectively, and the intermediate information qₛₕ is a value obtained by further adding a value of the bias parameter to a value obtained by adding all of values obtained by multiplying each of the values of the positive information bits by the weight parameter and values obtained by multiplying each of the values of the negative information bits by the weight parameter, as expressed by the equation (1).

Furthermore, learning is performed such that the latent variable vector has monotonicity with respect to the input vector. Here, description will be given on the premise that the available value range for the latent variable that is an element of the latent variable vector is [0, 1].

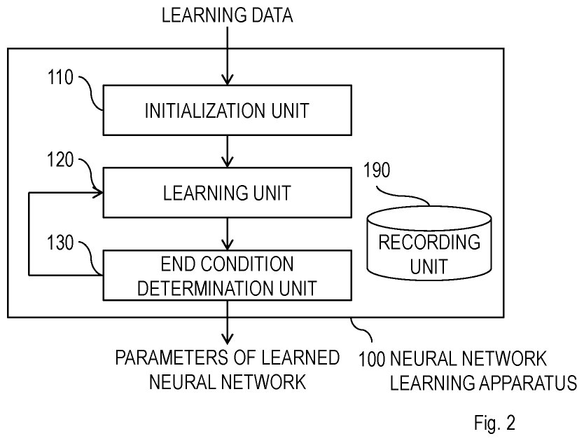

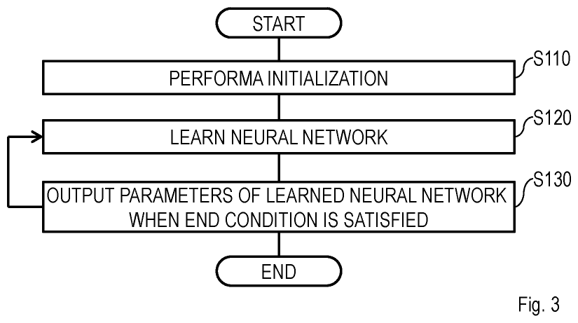

Hereinafter, the neural network learning apparatus 100 will be described with reference to FIGS. 2 and 3. FIG. 2 is a block diagram illustrating a configuration of the neural network learning apparatus 100. FIG. 3 is a flowchart illustrating an operation of the neural network learning apparatus 100. As illustrated in FIG. 2, the neural network learning apparatus 100 includes an initialization unit 110, a learning unit 120, an end condition determination unit 130, and a recording unit 190. The recording unit 190 is a configuration unit that appropriately records information necessary for processing of the neural network learning apparatus 100. The recording unit 190 records, for example, initialization data used for initialization of the neural network. Here, the initialization data is initial values of the parameters of the neural network, and is, for example, initial values of the weight parameter and the bias parameter of the encoder, and initial values of the weight parameters and the bias parameters of the decoder. Furthermore, the recording unit 190 may record the learning data in advance. Note that, since the learning data is an input to the encoder, the learning data is given as an input vector. In an example of analysis of test results, the learning data is the test results of a plurality of questions for a plurality of learners.

The operation of the neural network learning apparatus 100 will be described with reference to FIG. 3.

In S110, the initialization unit 110 performs initialization processing of the neural network using the initialization data. Specifically, the initialization unit 110 sets the initial value for each parameter of the neural network.

In S120, the learning unit 120 uses the learning data as an input, performs processing of updating each parameter of the neural network by using the learning data (hereinafter referred to as parameter update processing), and outputs the parameters of the neural network together with information (for example, the number of times the parameter update processing has been performed) necessary for the end condition determination unit 130 to determine an end condition. The learning unit 120 learns the neural network by, for example, a back propagation method using a loss function. That is, in each parameter update processing, the learning unit 120 performs processing of updating each parameter of the encoder and the decoder so that the loss function becomes small.

The loss function includes a term L_{RC} regarding a reconstruction error of the equation (2). That is, the loss function includes a loss term that is larger as the probability p(x) for the input information x is smaller in the case where the input information x is information indicating the positive state, is larger as the probability p(x) for the input information x is larger in the case where the input information x is information indicating the negative state, and is substantially 0 in the case where the input information x is information indicating the unknown state.

Further, the loss function includes a loss term for causing the latent variable vector to have the monotonicity with respect to the input vector. In a case where the monotonicity is monotonic increase, the loss function includes a term for causing the output vector to become larger as the latent variable vector is larger, for example, a term of a merge ranking error described in <Technical Background>. That is, the loss function includes, for example, at least one of a term setting a vector obtained by replacing a value of at least one element of the latent variable vector with a value smaller than the value of the one element as an artificial latent variable vector and having a larger value in a case where a value of a corresponding element of the output vector when the latent variable vector is input is smaller than a value of any element of the output vector when the artificial latent variable vector is input, or a term setting a vector obtained by replacing a value of at least one element of the latent variable vector with a value larger than the value of the one element as an artificial latent variable vector and having a larger value in a case where a value of a corresponding element of the output vector when the latent variable vector is input is larger than a value of any element of the output vector when the artificial latent variable vector is input. Alternatively, the loss function includes, for example, at least one of a term setting a vector obtained by replacing a value of at least one element of the latent variable vector with a value smaller than the value of the one element as an artificial latent variable vector and having a larger value in a case where a value of a corresponding element of the output vector when the latent variable vector is input is smaller than a value of any element indicating the positive state or the negative state of the elements of the output vector when the artificial latent variable vector is input, or a term setting a vector obtained by replacing a value of at least one element of the latent variable vector with a value larger than the value of the one element as an artificial latent variable vector and having a larger value in a case where a value of a corresponding element of the output vector when the latent variable vector is input is larger than a value of any element indicating the positive state or the negative state of the elements of the output vector when the artificial latent variable vector is input. Furthermore, in the case where the available value range of the elements of the latent variable vector is [0, 1], the loss function may include at least one term of a binary cross entropy of the latent variable vector of when the input vector is the vector in which the values of all the elements of the positive information bit group are the upper limit of 1 of the available value range and the values of all the elements of the negative information bit group are the lower limit of 0 of the available value range, and the vector (1, . . . , 1 (where the dimension of the vector is equal to the dimension of the latent variable vector), a binary cross entropy of the latent variable vector of when the input vector is the vector in which the values of all the elements of the positive information bit group are the lower limit of 0 of the available value range and the values of all the elements of the negative information bit group are the upper limit of 1 of the available value range, and the vector (0, . . . , 0 (where the dimension of the vector is equal to the dimension of the latent variable vector), a binary cross entropy of the output vector of when the latent variable vector is (1, . . . , 1) and the vector (1, . . . , 1 (where the dimension of the vector is equal to the dimension of the output vector), or a binary cross entropy of the output vector of when the latent variable vector is (0, . . . , 0) and the vector (0, . . . , 0 (where the dimension of the vector is equal to the dimension of the output vector).

On the other hand, in a case where the monotonicity is monotonic decrease, the loss function includes a term for making the output vector smaller as the latent variable vector is larger. That is, the loss function includes, for example, at least one of a term setting a vector obtained by replacing a value of at least one element of the latent variable vector with a value smaller than the value of the one element as an artificial latent variable vector and having a larger value in a case where a value of a corresponding element of the output vector when the latent variable vector is input is larger than a value of any element of the output vector when the artificial latent variable vector is input, or a term setting a vector obtained by replacing a value of at least one element of the latent variable vector with a value larger than the value of the one element as an artificial latent variable vector and having a larger value in a case where a value of a corresponding element of the output vector when the latent variable vector is input is smaller than a value of any element of the output vector when the artificial latent variable vector is input. Alternatively, the loss function includes, for example, at least one of a term setting a vector obtained by replacing a value of at least one element of the latent variable vector with a value smaller than the value of the one element as an artificial latent variable vector and having a larger value in a case where a value of a corresponding element of the output vector when the latent variable vector is input is larger than a value of any element indicating the positive state or the negative state of the elements of the output vector when the artificial latent variable vector is input, or a term setting a vector obtained by replacing a value of at least one element of the latent variable vector with a value larger than the value of the one element as an artificial latent variable vector and having a larger value in a case where a value of a corresponding element of the output vector when the latent variable vector is input is smaller than a value of any element indicating the positive state or the negative state of the elements of the output vector when the artificial latent variable vector is input.

Furthermore, in the case where the available value range of the elements of the latent variable vector is [0, 1], the loss function may include at least one term of a binary cross entropy of the latent variable vector of when the input vector is the vector in which the values of all the elements of the positive information bit group are the upper limit of 1 of the available value range and the values of all the elements of the negative information bit group are the lower limit of 0 of the available value range, and the vector (0, . . . , 0 (where the dimension of the vector is equal to the dimension of the latent variable vector), a binary cross entropy of the latent variable vector of when the input vector is the vector in which the values of all the elements of the positive information bit group are the lower limit of 0 of the available value range and the values of all the elements of the negative information bit group are the upper limit of 1 of the available value range, and the vector (1, . . . , 1 (where the dimension of the vector is equal to the dimension of the latent variable vector), a binary cross entropy of the values of the output vector of when the latent variable vector is (1, . . . , 1) and the vector (0, . . . , 0 (where the dimension of the vector is equal to the dimension of the output vector), or a binary cross entropy of the values of the output vector of when the latent variable vector is (0, . . . , 0) and the vector (1, . . . , 1 (where the dimension of the vector is equal to the dimension of the output vector).

In S130, the end condition determination unit 130 uses the parameters of the neural network output in S120 and the information necessary for determining the end condition output in S120 as inputs, and determines whether the end condition that is a condition regarding the end of learning is satisfied (for example, the number of times the parameter update processing has been performed has reached a predetermined number of times of repetition). In a case where the end condition is satisfied, the end condition determination unit 130 outputs the parameters of the neural network obtained in S120 that has been performed last as the parameters of the learned neural network and terminates the processing, while in a case where the end condition is not satisfied, the processing returns to the processing in S120.

### Modification

The available value range for the latent variable that is an element of the latent variable vector may be [m, M](where m<M), instead of [0, 1]. Furthermore, the available value range for each element of the latent variable vector may be individually set. In this case, the term included in the loss function may be set as follows, where the number of the element of the latent variable vector is j (j is an integer of 1 or more and J or less, and J is an integer of 2 or more) and the available value range for the j-th element is [mⱼ, Mⱼ](where mⱼ<Mⱼ). Furthermore, in the case where the monotonicity is monotonic increase, the loss function includes at least one term of a cross entropy of the latent variable vector of when the input vector is the vector in which the values of all the elements of the positive information bit group are the upper limit of 1 of the available value range and the values of all the elements of the negative information bit group are the lower limit of 0 of the available value range, and the vector (M₁, . . . , M_{J}), a cross entropy of the latent variable vector of when the input vector is the vector in which the values of all the elements of the positive information bit group are the lower limit of 0 of the available value range and the values of all the elements of the negative information bit group are the upper limit of 1 of the available value range, and the vector (m₁, . . . , m_{J}), a cross entropy of the output vector of when the latent variable vector is (M₁, . . . , M_{J}) and the vector (1, . . . , 1 (where the dimension of the vector is equal to the dimension of the output vector), or a cross entropy of the output vector of when the latent variable vector is (m₁, . . . , m_{J}) and the vector (0, . . . , 0 (where the dimension of the vector is equal to the dimension of the output vector).

Meanwhile, in the case where the monotonicity is monotonic decrease, the loss function includes at least one term of a cross entropy of the latent variable vector of when the input vector is the vector in which the values of all the elements of the positive information bit group are the upper limit of 1 of the available value range and the values of all the elements of the negative information bit group are the lower limit of 0 of the available value range, and the vector (m₁, . . . , m_{J}), a cross entropy of the latent variable vector of when the input vector is the vector in which the values of all the elements of the positive information bit group are the lower limit of 0 of the available value range and the values of all the elements of the negative information bit group are the upper limit of 1 of the available value range, and the vector (M₁, . . . , M_{J}), a cross entropy of the output vector of when the latent variable vector is (M₁, . . . , M_{J}) and the vector (0, . . . , 0 (where the dimension of the vector is equal to the dimension of the output vector), or a cross entropy of the output vector of when the latent variable vector is (m₁, . . . , m_{J}) and the vector (1, . . . , 1 (where the dimension of the vector is equal to the dimension of the output vector). Note that the above-described cross entropies are examples of a value corresponding to magnitude of a difference between vectors, and for example, a value such as a mean squared error (MSE) that increases when the difference between vectors is large can be used instead of the above-described cross entropies.

According to the embodiment of the present invention, it is possible to learn a neural network including an encoder and a decoder, which can estimate a state of input information indicating an unknown state as a probability for the input information. As a result, for example, it is possible to learn a neural network that predicts a probability that a learner will correctly answer a question that the learner has not taken.

### Second Embodiment

In the first embodiment, a mode of learning the neural network having monotonicity by using the loss function including the loss term for causing the latent variable vector to have monotonicity with respect to the input vector has been described. Here, a mode of learning a neural network having monotonicity by performing learning so that a weight parameter of a decoder satisfies a predetermined condition will be described.

A neural network learning apparatus 100 of the present embodiment is different from the neural network learning apparatus 100 of the first embodiment only in an operation of a learning unit 120. Therefore, only the operation of the learning unit 120 will be described below.

In S120, the learning unit 120 uses the learning data as an input, performs processing of updating each parameter of the neural network by using the learning data (hereinafter referred to as parameter update processing), and outputs the parameters of the neural network together with information (for example, the number of times the parameter update processing has been performed) necessary for the end condition determination unit 130 to determine an end condition. The learning unit 120 learns the neural network by, for example, a back propagation method using a loss function. That is, in each parameter update processing, the learning unit 120 performs processing of updating each parameter of the encoder and the decoder so that the loss function becomes small.

The loss function includes a term L_{RC} regarding a reconstruction error of the equation (2). That is, the loss function includes a loss term that is larger as the probability p(x) for the input information x is smaller in the case where the input information x is information indicating the positive state, is larger as the probability p(x) for the input information x is larger in the case where the input information x is information indicating the negative state, and is substantially 0 in the case where the input information x is information indicating the unknown state.

Further, the neural network learning apparatus 100 according to the present embodiment performs learning in such a manner that the weight parameter of the decoder satisfies a predetermined condition. In a case where the neural network learning apparatus 100 performs learning so that a latent variable vector has a relationship of monotonically increasing with respect to the input vector, the neural network learning apparatus 100 performs learning so as to satisfy a condition that all the weight parameters of the decoder are non-negative. That is, in this case, in each parameter update processing performed by the learning unit 120, each parameter of the encoder and the decoder is updated by restricting the weight parameters of the decoder to be non-negative values. More specifically, the decoder included in the neural network learning apparatus 100 includes a layer for obtaining a plurality of output values from a plurality of input values, each output value of the layer includes a term obtained by giving the weight parameter to each of the plurality of input values and adding the plurality of input values, and each parameter update processing performed by the learning unit 120 satisfies the condition that the weight parameters of the decoder are non-negative values. Note that the term obtained by giving the weight parameter to each of the plurality of input values and adding the plurality of input values can also be referred to as a term obtained by adding all values obtained by multiplying each of the input values and the weight parameter corresponding to the each of the input values, a term obtained by weighting and adding the plurality of input values using the weight parameter corresponding to each of the plurality of input values as a weight, or the like.

On the other hand, in a case where the neural network learning apparatus 100 performs learning so that the latent variable vector has a relationship of monotonically decreasing with respect to the input vector, the learning is performed so as to satisfy a condition that all the weight parameters of the decoder are non-positive. That is, in this case, in each parameter update processing performed by the learning unit 120, each parameter of the encoder and the decoder is updated by restricting all the weight parameters of the decoder to be non-positive values. More specifically, the decoder included in the neural network learning apparatus 100 includes a layer for obtaining a plurality of output values from a plurality of input values, each output value of the layer includes a term obtained by giving the weight parameter to each of the plurality of input values and adding the plurality of input values, and each parameter update processing performed by the learning unit 120 satisfies the condition that all the weight parameters of the decoder are non-positive values.

In the case where the neural network learning apparatus 100 performs learning so as to satisfy the condition that all the weight parameters of the decoder are non-negative, an initial value of the weight parameters of the decoder in initialization data recorded by a recording unit 190 is preferably a non-negative value. Similarly, in the case where the neural network learning apparatus 100 performs learning so as to satisfy the condition that all the weight parameters of the decoder are non-positive, the initial value of the weight parameters of the decoder in the initialization data recorded by the recording unit 190 is preferably a non-positive value.

According to the embodiment of the present invention, it is possible to learn a neural network including an encoder and a decoder, which can estimate a state of input information indicating an unknown state as a probability for the input information. As a result, for example, it is possible to learn a neural network that predicts a probability that a learner will correctly answer a question that the learner has not taken.

### Third Embodiment

In the present embodiment, a state estimation apparatus that estimates a state of input information indicating an unknown state using a learned neural network learned using the first embodiment and the second embodiment will be described. Here, setting input information as information indicating one of a positive state, a negative state, or an unknown state, setting an input vector as a vector obtained from K pieces (K is an integer of 2 or more) of input information x₁, . . . , x_{K} by expressing the input information using two bits of a positive information bit set to 1 when the input information is information indicating the positive state, or set to 0 when the input information is information indicating the unknown state or information indicating the negative state, and a negative information bit set to 1 when the input information is information indicating the negative state, or set to 0 when the input information is information indicating the unknown state or information indicating the positive state, setting p(x) as a probability that input information x is information indicating the positive state, setting an output vector as a vector having probabilities p(x₁), . . . , p(x_{K}) for the K pieces of input information x₁, . . . , x_{K} as elements, the learned neural network is a neural network including an encoder that calculates a latent variable vector having a latent variable as an element from the input vector and a decoder that calculates an output vector from the latent variable vector and having performed learning by repeating parameter update processing of updating parameters of the encoder and the decoder such that the latent variable vector has monotonicity with respect to the input vector by using a loss function including a loss term that is larger as the probability p(x) for the input information x is smaller in a case where the input information x is information indicating a positive state, is larger as the probability p(x) for the input information x is larger in a case where the input information x is information indicating a negative state, and is substantially 0 in a case where the input information x is information indicating an unknown state.

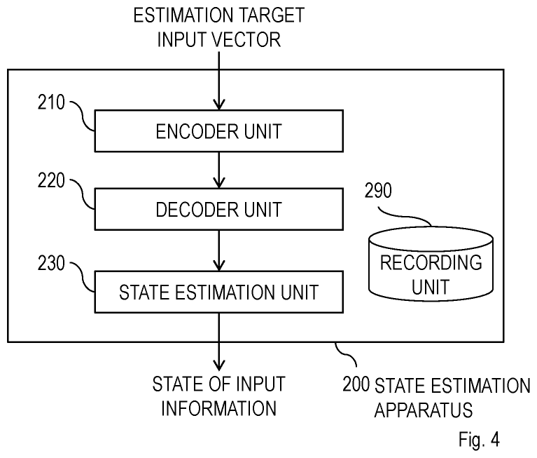

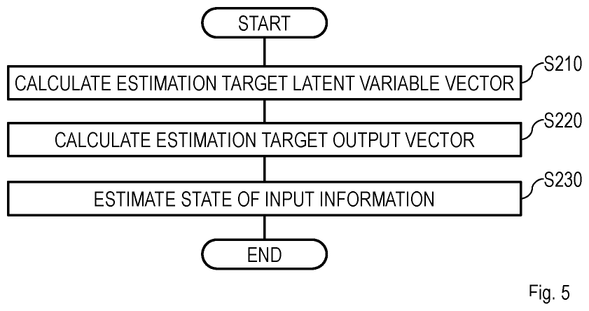

Hereinafter, a state estimation apparatus 200 will be described with reference to FIGS. 4 and 5. FIG. 4 is a block diagram illustrating a configuration of the state estimation apparatus 200. FIG. 5 is a flowchart illustrating an operation of the state estimation apparatus 200. As illustrated in FIG. 4, the state estimation apparatus 200 includes an encoder unit 210, a decoder unit 220, a state estimation unit 230, and a recording unit 290. The recording unit 290 is a configuration unit that appropriately records information necessary for processing of the state estimation apparatus 200. The recording unit 290 records the parameters of the learned neural network, for example.

The operation of the state estimation apparatus 200 will be described with reference to FIG. 5.

In S210, the encoder unit 210 uses an estimation target input vector obtained from the K pieces of input information x₁, . . . , and x_{K} as an input, calculates an estimation target latent variable vector from the estimation target input vector using the encoder of the learned neural network, and outputs the estimation target latent variable vector.

In S220, the decoder unit 220 uses the estimation target latent variable vector calculated in S210 as an input, calculates an estimation target output vector from the estimation target latent variable vector using a decoder of the learned neural network, and outputs the estimation target output vector.

In S230, the state estimation unit 230 uses the estimation target output vector calculated in S220 as input, obtains a probability p(xₖ) corresponding to the input information xₖ (here, k satisfies 1≤k≤K) indicating the unknown state from the estimation target output vector, and outputs the probability p(xₖ) as an estimated probability that the input information xₖ is in the positive state.

According to the embodiment of the present invention, it is possible to estimate a state of input information indicating an unknown state as a probability for the input information. As a result, for example, it is possible to predict a probability that a learner will correctly answer a question that the learner has not taken among a plurality of questions from test results of questions that the estimation target learner has taken among the plurality of questions.

### Fourth Embodiment

In the present embodiment, a question recommendation apparatus that recommends a question to be solved by a recommendation target learner, using a learned neural network learned using the first embodiment or the second embodiment will be described. Here, K pieces of input information are set as test results of K questions, and a positive state, a negative state, and an unknown state are set as a correct answer, a wrong answer, and no answer, respectively.

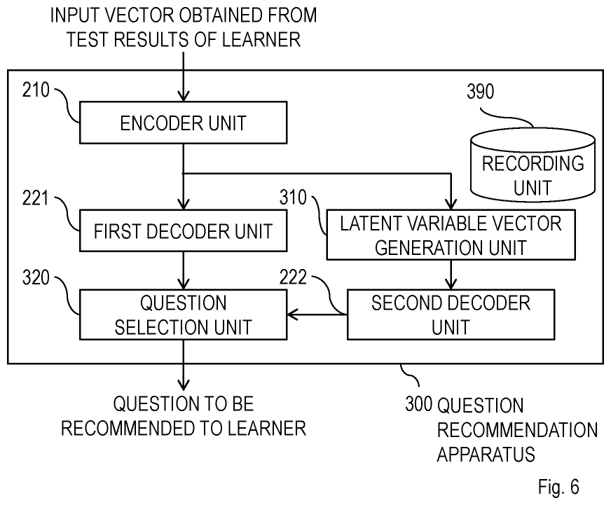

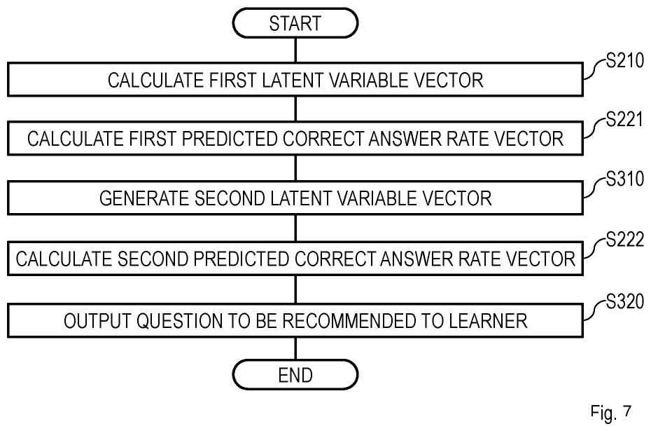

Hereinafter, a question recommendation apparatus 300 will be described with reference to FIGS. 6 and 7. FIG. 6 is a block diagram illustrating a configuration of the question recommendation apparatus 300. FIG. 7 is a flowchart illustrating an operation of the question recommendation apparatus 300. As illustrated in FIG. 6, the question recommendation apparatus 300 includes an encoder unit 210, a first decoder unit 221, a latent variable vector generation unit 310, a second decoder unit 222, a question selection unit 320, and a recording unit 390. The recording unit 390 is a configuration unit that appropriately records information necessary for processing by the question recommendation apparatus 300.

The operation of the question recommendation apparatus 300 will be described with reference to FIG. 7.

In S210, the encoder unit 210 uses input vector obtained from the test results of the recommendation target learner for the K questions as an input, calculates a first latent variable vector from the input vector using an encoder of the learned neural network, and outputs the first latent variable vector.

In S221, the first decoder unit 221 uses the first latent variable vector calculated in S210 as an input, and calculates an output vector (hereinafter referred to as a first predicted correct answer rate vector) from the first latent variable vector using a decoder of the learned neural network, and outputs the output vector.

In S310, the latent variable vector generation unit 310 uses the first latent variable vector calculated in S210 as an input, and generates a second latent variable vector from the first latent variable vector by a predetermined method, and outputs the second latent variable vector.

In a case where monotonicity is monotonic increase, the latent variable vector generation unit 310 generates a vector obtained by replacing at least one element of elements of the first latent variable vector with a value larger than the value of the one element as the second latent variable vector. Further, in a case where monotonicity is monotonic decrease, the latent variable vector generation unit 310 generates a vector obtained by replacing at least one element of the elements of the first latent variable vector with a value smaller than the value of the one element as the second latent variable vector. The second latent variable vector generated in this way corresponds to academic ability of the recommendation target learner in which the ability of a category corresponding to the element with the replaced value has been virtually improved. Therefore, by the latent variable vector generation unit 310 generating the second latent variable vector in this manner, the question recommendation apparatus 300 can recommend a question for improving the ability of the recommendation target learner.

In the case where monotonicity is a monotonic increase, the latent variable vector generation unit 310 generates a vector obtained by replacing an element with a minimum value of the elements of the first latent variable vector with a value larger than the value with the minimum value as the second latent variable vector. In the case where monotonicity is a monotonic decrease, the latent variable vector generation unit 310 generates a vector obtained by replacing an element with a maximum value of the elements of the first latent variable vector with a value smaller than the value with the maximum value as the second latent variable vector. The second latent variable vector generated in this manner corresponds to the academic ability of the recommendation target learner in which the ability of the category that the recommendation target learner is most not good at has been virtually improved. Therefore, by the latent variable vector generation unit 310 generating the second latent variable vector in this manner, the question recommendation apparatus 300 can recommend a question for improving the ability of the category that the recommendation target learner is the most not good at.

Furthermore, setting i₁, . . . , i_{M} (where M is an integer of 1 or more and K or less, iₘ (m=1, . . . , M) satisfies 1≤iₘ≤K, and iₘ and i_{m′} (m≠m′) are different from each other) as indexes of the elements of the first latent variable vector whose values are replaced, setting z_{i_1}, . . . , z_{i_M} as values of the elements i₁, . . . , i_{M} of the first latent variable vector, and setting p as a median value of a latent variable value range, in the case where the monotonicity is a monotonic increase, the latent variable vector generation unit 310 may generate a vector obtained by replacing an element of the first latent variable vector whose index iₘ satisfies z_{i_m}<μ with z_{i_m}+(μ−z_{i_m})/2 as the second latent variable vector. Furthermore, in the case where the monotonicity is a monotonic decrease, the latent variable vector generation unit 310 may generate a vector obtained by replacing an element of the first latent variable vector whose index iₘ satisfies μ<z_{i_m} with z_{i_m}−(z_{i_m}−μ)/2 as the second latent variable vector. By the latent variable vector generation unit 310 generating the second latent variable vector in this manner, the question recommendation apparatus 300 can recommend a question for halving the degree of difficulty in the ability of the category that the recommendation target learner is not good at.

In S222, the second decoder unit 222 uses the second latent variable vector calculated in S310 as an input, and calculates an output vector (hereinafter referred to as a second predicted correct answer rate vector) from the second latent variable vector using the decoder of the learned neural network, and outputs the output vector.

In S320, the question selection unit 320 uses the first predicted correct answer rate vector calculated in S221 and the second predicted correct answer rate vector calculated in S222 as inputs, generates a vector obtained by subtracting the first predicted correct answer rate vector from the second predicted correct answer rate vector as a difference vector, preferentially selects an element having a larger value from elements of the difference vector, and obtains and outputs a question corresponding to an index of the selected element as a question to be recommended to the recommendation target learner. For example, the question selection unit 320 selects a predetermined number of elements in descending order of values of the elements from among the elements of the difference vector. Furthermore, the question selection unit 320 selects, for example, an element having a value larger than, or larger than or equal to a predetermined value from among the elements of the difference vector.

Note that even in a case of a question corresponding to an index having a large value of the element of the difference vector, a question that has been taken by the recommendation target learner may not be selected as the question to be recommended. In other words, the question selection unit 320 may preferentially select an element having a larger value from among elements corresponding to questions that have not yet been taken by the recommendation target learner, of the elements of the difference vector, and obtain a question corresponding to the index of the selected element as the question to be recommended to the recommendation target learner. However, for example, a question that has been taken by the recommendation target learner but a considerable time has elapsed since the examination may be selected as the question to be recommended. In other words, the question selection unit 320 may preferentially select an element having a larger value from among elements corresponding to questions that have not yet been taken by the recommendation target learner and questions that a predetermined time has elapsed since the recommendation target learner took the examination, of the elements of the difference vector, and obtain a question corresponding to the index of the selected element as the question to be recommended to the recommendation target learner.

Note that, for the processing of S221 and the processing of S310 and S222, either processing may be executed first, or the two pieces of processing may be simultaneously executed.

According to the embodiment of the present invention, it is possible to recommend a question suitable for use in future study as a question to be solved to the recommendation target learner.

### Modification

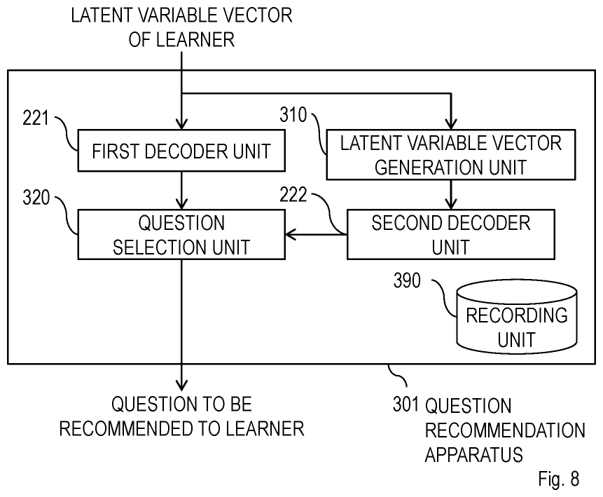

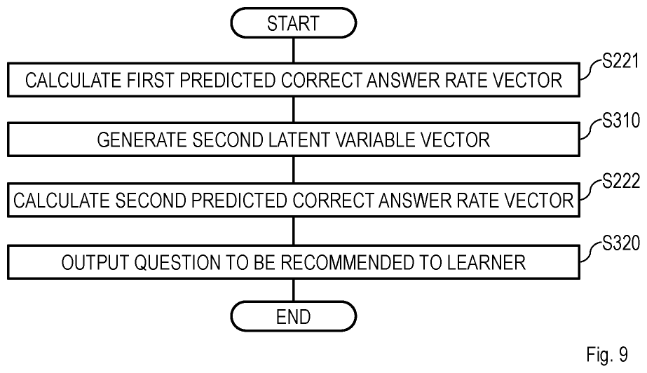

There may be a case where analysis of test results of the recommendation target learner has been completed, and the latent variable vector indicating the ability of the learner has already been obtained. In this case, as illustrated in FIGS. 8 and 9, the question recommendation apparatus 301 uses the latent variable vector of the recommendation target learner as an input instead of the input vector obtained from the test results of the recommendation target learner, and may input the latent variable vector to be recommended input to the question recommendation apparatus 301 to the first decoder unit 221 and the latent variable vector generation unit 310 as the first latent variable vector, and perform the above-described processing of S221, S310, S222, and S320.

### SUPPLEMENTARY NOTE

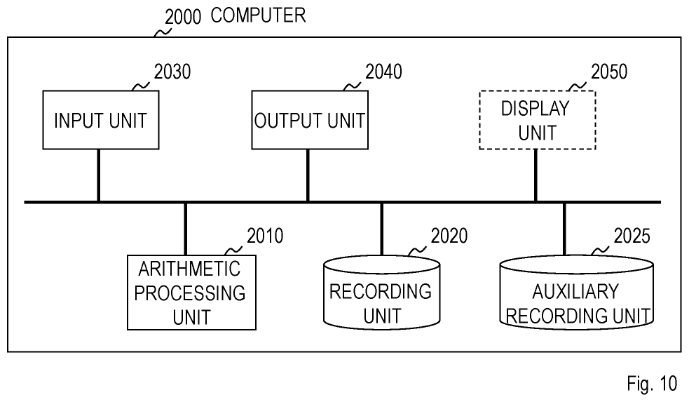

Processing of each unit of each device described above may be implemented by a computer, and in this case, processing contents of a function that each device should have are written by a program. Then, by causing a recording unit 2020 of a computer 2000 illustrated in FIG. 10 to read this program and causing an arithmetic processing unit 2010, an input unit 2030, an output unit 2040, an auxiliary recording unit 2025, and the like to operate, various processing functions in each device described above are implemented on the computer.

The device of the present invention includes, for example, as a single hardware entity, an input unit to which a signal can be input from the outside of the hardware entity, an output unit through which a signal can be output to the outside of the hardware entity, a communication unit to which a communication device (for example, a communication cable) capable of communicating with the outside of the hardware entity can be connected, a CPU (Central Processing Unit, which may include a cache memory, a register, and the like) which is an arithmetic processing unit, a RAM and a ROM which are memories, an external storage device which is a hard disk, and a bus connected such that the input unit, the output unit, the communication unit, the CPU, the RAM, the ROM, and the external storage device can exchange data. A device (drive) or the like that can write and read data in and from a recording medium such as a CD-ROM may be provided in the hardware entity as necessary. Examples of a physical entity including such a hardware resource include a general-purpose computer and the like.

The external storage device of the hardware entity stores a program required to implement the above-described functions, data required to process the program, and the like (the present invention is not limited to the external storage device and the program may be stored, for example, in a ROM, which is a read-only storage device). Data or the like obtained by processing the program is appropriately stored in a RAM, an external storage device, or the like.

In the hardware entity, each program stored in the external storage device (or the ROM or the like) and data required for processing by each program are read into a memory as necessary and are appropriately interpreted, executed, and processed by the CPU. As a result, the CPU implements predetermined functions (each of the constituent units represented as . . . unit, . . . means, etc.). That is, each of the constituent units of the embodiments of the present invention may include processing circuitry.

As described above, when the processing function of the hardware entity (the device according to the present invention) described in the foregoing embodiment is implemented by a computer, processing content of the function of the hardware entity is described by a program. In addition, as the computer executes the program, the processing function of the hardware entity is implemented on the computer.

The program in which the processing content is written may be recorded on a computer-readable recording medium. The computer-readable recording medium is, for example, a non-transitory recording medium and is specifically a magnetic recording device, an optical disc, or the like.

In addition, the program is distributed by, for example, selling, transferring, or renting a portable recording medium such as a DVD or a CD-ROM on which the program is recorded. Further, the program may be stored in a storage device of a server computer, and the program may be distributed by transferring the program from the server computer to another computer via a network.

For example, the computer that executes such a program first temporarily saves the program recorded in the portable recording medium or the program transferred from the server computer in the auxiliary recording unit 2025 as the own non-transitory storage device of the computer. Then, at the time of executing processing, this computer reads the program saved in the auxiliary recording unit 2025 as the own non-transitory storage device of the computer into the recording unit 2020 and executes processing in accordance with the read program. As another mode of executing this program, the computer may directly read the program from the portable recording medium into the recording unit 2020 and execute processing in accordance with the read program, or alternatively, each time the program is transferred to this computer from the server computer, the computer may sequentially execute processing in accordance with the received program. Moreover, the above-described processing may be executed by a so-called ASP (Application Service Provider) type service that implements a processing function only by an execution instruction and result acquisition without transferring the program from a server computer to the computer. Note that the program in the present form includes information that is used for processing by an electronic computer and is equivalent to the program (data or the like that is not a direct command to the computer but has property that defines processing performed by the computer).

In addition, although the present devices are each configured by executing a predetermined program on a computer in this form, at least a part of the processing content may be implemented by hardware.

The present invention is not limited to the above-described embodiments and can be appropriately modified without departing from the gist of the present invention.

1. A question recommendation apparatus comprising:
setting input information as information indicating one of a positive state, a negative state, or an unknown state,
setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state,
setting p(x) as a probability that the input information x is information indicating the positive state,
setting an output vector as a vector having probabilities p(x₁), . . . , p(x_{K}) for the K pieces of input information x₁, . . . , x_{K} as elements,
a processing circuitry configured to record a parameter of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder so that the latent variable vector has monotonicity with respect to the input vector, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state;
setting the K pieces of input information as test results of K questions, and setting the positive state, the negative state, and the unknown state as a correct answer, a wrong answer, and no answer, respectively,
setting a first latent variable vector as a latent variable vector calculated from an input vector obtained from the test results of a learner of the K questions by using an encoder of the learned neural network or a latent variable vector corresponding to the input vector,
calculate an output vector (hereinafter referred to as a first predicted correct answer rate vector) from the first latent variable vector using a decoder of the learned neural network;
generate, as a second latent variable vector, a vector obtained by replacing at least one element of elements of the first latent variable vector with a value larger than a value of the element in a case where the monotonicity is monotonic increase, or a vector obtained by replacing at least one element of the elements of the first latent variable vector with a value smaller than the value of the element in a case where the monotonicity is monotonic decrease;
calculate an output vector (hereinafter referred to as a second predicted correct answer rate vector) from the second latent variable vector using the decoder of the learned neural network; and
generate a vector obtained by subtracting the first predicted correct answer rate vector from the second predicted correct answer rate vector as a difference vector, preferentially select an element having a larger value from elements of the difference vector, and obtain a question corresponding to an index of the selected element as a question to be recommended to the learner.

2. The question recommendation apparatus according to claim 1, wherein
the processing circuitry generates, as the second latent variable vector, a vector obtained by replacing an element having a minimum value of the elements of the first latent variable vector with a value larger than the minimum value of the element in the case where the monotonicity is monotonic increase, or a vector obtained by replacing an element having a maximum value of the elements of the first latent variable vector with a value smaller than the maximum value of the element in the case where the monotonicity is monotonic decrease.

3. The question recommendation apparatus according to claim 1, wherein
setting i₁, . . . , i_{M} (where M is an integer of 1 or more and K or less, iₘ (m=1, . . . , M) satisfies 1≤iₘ≤K, and iₘ and i_{m′} (m≠m′) are different from each other) as indexes of the elements of the first latent variable vector whose values are replaced, setting z_{i_1}, . . . , z_{i_M} as values of the elements i₁, . . . , and i_{M} of the first latent variable vector, and setting as a median value of a latent variable value range, and
the processing circuitry generates, as the second latent variable vector, a vector obtained by replacing an element of the first latent variable vector whose index iₘ satisfies z_{i_m}<μ with z_{i_m}+(μ−z_{i_m})/2 in the case where the monotonicity is monotonic increase, or a vector obtained by replacing an element of the first latent variable vector whose index iₘ satisfies μ<z_{i_m} with z_{i_m}−(z_{i_m}−μ)/2 in the case where the monotonicity is monotonic decrease.

4. The question recommendation apparatus according to claim 1, wherein
the processing circuitry selects a predetermined number of elements in descending order of values of the elements from among the elements of the difference vector.

5. The question recommendation apparatus according to claim 1, wherein
the processing circuitry selects an element having a value larger than, or larger than or equal to a predetermined value from among the elements of the difference vector.

6. A question recommendation method comprising:
setting input information as information indicating one of a positive state, a negative state, or an unknown state;
setting an input vector as a vector obtained from K pieces (K is an integer of 2 or more) of the input information x₁, . . . , x_{K} by expressing the input information using two bits of a positive information bit set to 1 in a case where the input information is information indicating the positive state, or set to 0 in a case where the input information is information indicating the unknown state or information indicating the negative state, and a negative information bit set to 1 in a case where the input information is information indicating the negative state, or set to 0 in a case where the input information is information indicating the unknown state or information indicating the positive state;
setting p(x) as a probability that the input information x is information indicating the positive state;
setting an output vector as a vector having probabilities p(x₁), . . . , p(x_{K}) for the K pieces of input information x₁, . . . , x_{K} as elements;
setting the K pieces of input information as test results of K questions, and setting the positive state, the negative state, and the unknown state as a correct answer, a wrong answer, and no answer, respectively,
setting a first latent variable vector as a latent variable vector calculated from an input vector obtained from the test results of a learner of the K questions by using an encoder of the learned neural network or a latent variable vector corresponding to the input vector,
a first decoder step of, by a question recommendation apparatus including a processing circuitry configured to record a parameter of a learned neural network, including an encoder that calculates a latent variable vector having a latent variable as an element from the input vector and a decoder that calculates an output vector from the latent variable vector, that has been learned by repeating parameter update processing of uprating parameters of the encoder and the decoder so that the latent variable vector has monotonicity with respect to the input vector, using a loss function including a loss term that has a larger value as the probability p(x) for the input information x is smaller in a case where the input information x is information indicating the positive state, has a larger value as the probability p(x) for the input information x is larger in a case where the input information x is information indicating the negative state, and is substantially 0 in a case where the input information x is information indicating the unknown state, calculating an output vector (hereinafter referred to as a first predicted correct answer rate vector) from the first latent variable vector using a decoder of the learned neural network;
a latent variable vector generation step of, by the question recommendation apparatus, generating, as a second latent variable vector, a vector obtained by replacing at least one element of elements of the first latent variable vector with a value larger than a value of the element in a case where the monotonicity is monotonic increase, or a vector obtained by replacing at least one element of the elements of the first latent variable vector with a value smaller than the value of the element in a case where the monotonicity is monotonic decrease;
a second decoder step of, by the question recommendation apparatus, calculating an output vector (hereinafter referred to as a second predicted correct answer rate vector) from the second latent variable vector using the decoder of the learned neural network; and
a question selection step of, by the question recommendation apparatus, generating a vector obtained by subtracting the first predicted correct answer rate vector from the second predicted correct answer rate vector as a difference vector, preferentially selecting an element having a larger value from elements of the difference vector, and obtaining a question corresponding to an index of the selected element as a question to be recommended to the learner.

7. A non-transitory computer-readable storage medium which stores a program for causing a computer to function as the question recommendation apparatus according to claim 1.
